(19) United States
(12) Patent Application Publication
(10) Pub. No.: US 2002/0011744 A1
(43) Pub. Date: Jan. 31, 2002

(54) Opening roof

(75) Inventor: Johannes Nicolaas Huyer, BJ Zandvoort (NL)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Hollandia Weathershields Limited

(21) Appl. No.: 09/972,589

(22) Filed: Oct. 5, 2001

Related U.S. Application Data
(63) Continuation of application No. 09/715,471, filed on Nov. 16, 2000, now abandoned.
Application No. 09/715,471 is a continuation of application No. 09/512,136, filed on Feb. 23, 2000, now abandoned.
Application No. 09/512,136 is a continuation of application No. 08/978,663, filed on Nov. 26, 1997, now abandoned.

(30) Foreign Application Priority Data
Nov. 29, 1996 (GB) 9624866.1

(51) Int. Cl. B60J 7/06

(52) U.S. Cl. 296/219

(57) ABSTRACT

A fabric roof assembly is disclosed which can be electrically operated comprises a plurality of transverse cross-members adapted to slide in guide rails which extend along each side of an opening of the roof. The assembly includes a front member which supports a front end of the fabric panel, movement of the front member within the opening causing the fabric panel to move from an open position to a position covering the opening. A tensioning and closing mechanism is carried by the front member to tension and close the roof, and driving members are provided which slide along the guides rails and to operate with the front member through the tensioning and closing mechanism. The driving member is the only part which needs to work in the guide rails, with the tensioning and closing mechanism supported by the front member. This allows the walls of the guide rails to be kept to a minimum. The disclosed assembly allows the fabric roof to be tensioned during closing and to form a seal over the opening when fully closed.

The invention relates to a fabric roof assembly of the kind adapted to cover a longitudinal opening in a vehicle roof.

It is well known to provide a fabric folding roof assembly comprising a flexible fabric panel which is supported by a series of transverse cross-members adapted to slide in guide rails which, extend longitudinally along each side of the longitudinal roof opening. A front member supports both the front end of the fabric panel and a substantially rigid transverse flap. On closing the fabric roof assembly to cover the opening, it is important that the flap is forcibly drawn forwards in order to tension the fabric panel, and simultaneously drawn downwards to form a seal with the front of the roof opening. Motive force to open and close the panel is provided by an electric motor which acts through cables or the like directly or indirectly to slide the front member along the guide rails, and hence open or close the opening.

A problem arising with such a known roof assembly is that in order to exert the required tension on the roof panel, a powerful motor is needed. Typically, the force required to tension the panel during the final stages of closing is of the order of 20 to 25 times the force required to move the cross-members and front member along the guide rails. Hence, a powerful motor must be employed if the tensioning of the fabric panel is to be achieved by simply driving the cross-member forward along the guide rails.

In order to overcome the need for a powerful motor it is known from EP-A-0 336 414 to provide a tensioning mechanism within the guide rails at the sides of the opening. A disadvantage of this is that the guide rails need to be quite wide in order to accommodate the tensioning mechanism.

According to our invention, in a fabric roof assembly for a vehicle comprising a flexible fabric panel supported by a series of transverse cross-members adapted to slide in guide rails which extend longitudinally along each side of a longitudinal opening adapted to be closed by the fabric panel, and including a front cross-member supporting the front end of the fabric panel, the assembly is characterised by further comprising a tensioning mechanism and closing mechanism carried by the front member to tension and close the fabric panel as the roof is being closed, and driving members adapted to slide along the guide rails co-operate with the front member through the tensioning and closing mechanism to move the front member in a direction to close the roof.

This has the advantage that the mechanism for tensioning the fabric panel is attached to the front-member so that only the means for guiding the panel within the roof opening is provided in the guide rails. This allows the width of the guide rails to be kept to a minimum.

A first end portion of the tensioning mechanism may be hingeably fixed to the driving member and a second end portion of the tensioning mechanism may be adapted to slide within a guide channel in the guide rail so that on movement of the driving member from a first open position to an intermediate position between the first position and a second closed position, the first and second end portions are fixed relatively to one another so that the cross-member moves at the same rate as the driving member, and on further movement of the driving member from the intermediate position to the second position, the first and second end positions are displaced relative to one another so that the cross-member moves at a slower rate than the driving member.

In this way, the tensioning of the roof panel can be readily achieved because of the mechanical advantage obtained by the difference in the rate of movement of the driving member and the cross-member.

The intermediate position may be defined by a locking opening provided in the guide rail into which the second end portion of the tensioning mechanism is engaged. The locking opening holds the second end portion captive once the driving member reaches the intermediate position so that on further movement of the driving member towards the second position, only the first end portion continues to move with the driving member.

Preferably, the second end portion of the tensioning mechanism is adapted to slide in a channel provided in the driving member. The profile of the channel may co-operate with the profile of a groove in the guide rail to prevent the second end portion moving relatively to the first end portion between the first and intermediate positions, and retaining the second end portion in the locking opening during movement of the driving member between the intermediate position and the second position.

The first and second end portions of the tensioning mechanism may define the respective ends of a driving lever and a braking lever which are both pivotally and slidably attached to the cross member, the levers being arranged so as to co-operate in a manner whereby a large relative movement of the first end portion of the tensioning mechanism (i.e. the end of the driving lever) away from the second end portion of the tensioning mechanism (i.e. the end of the locking lever) produces the smaller movement of the cross-member in the direction of movement of the first end portion.

The levers therefore provide the mechanism for enabling the cross member to continue forwards movement after the second end portion of the tensioning mechanism engages the locking opening, at a slower rate than the driving member is moved. This allows correct tensioning to be achieved.

The first end portion may further be adapted to pass through an opening in the end of the cross member, with the opening having a profile so that as the first end portion is moved away from the second end portion, the first end portion moves along the channel to cause the front edge of the cross member to move downwards to effect a seal with the front of the opening.

The roof may be manually or electrically operated. When the roof is electrically operated the driving members are adapted to slide along the guide rail under the control of an electric motor.

There will now be described by way of example only, one embodiment of the present invention with the aid of the following drawings in which:

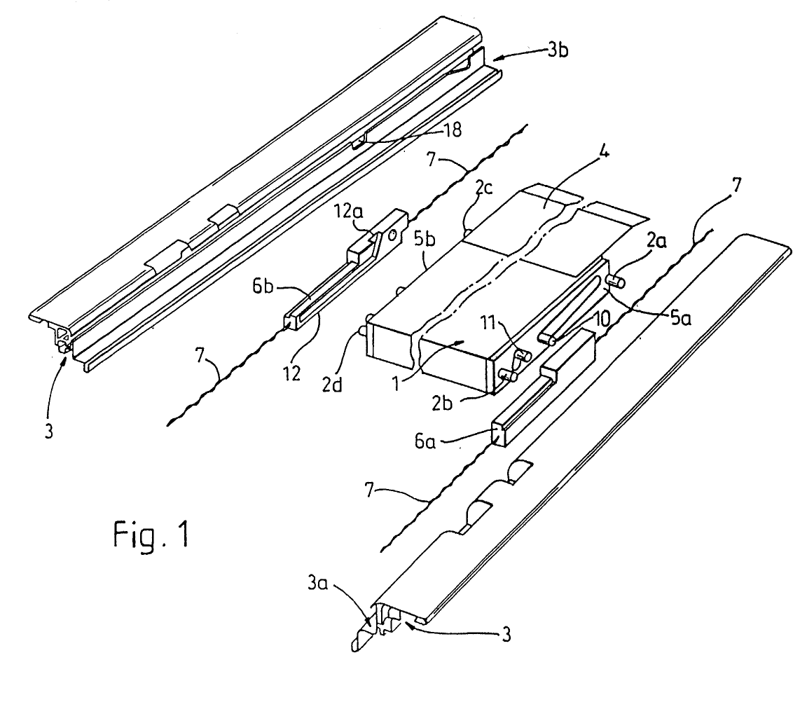

FIG. 1 shows an exploded isometric view of a closing mechanism in accordance with the present invention;

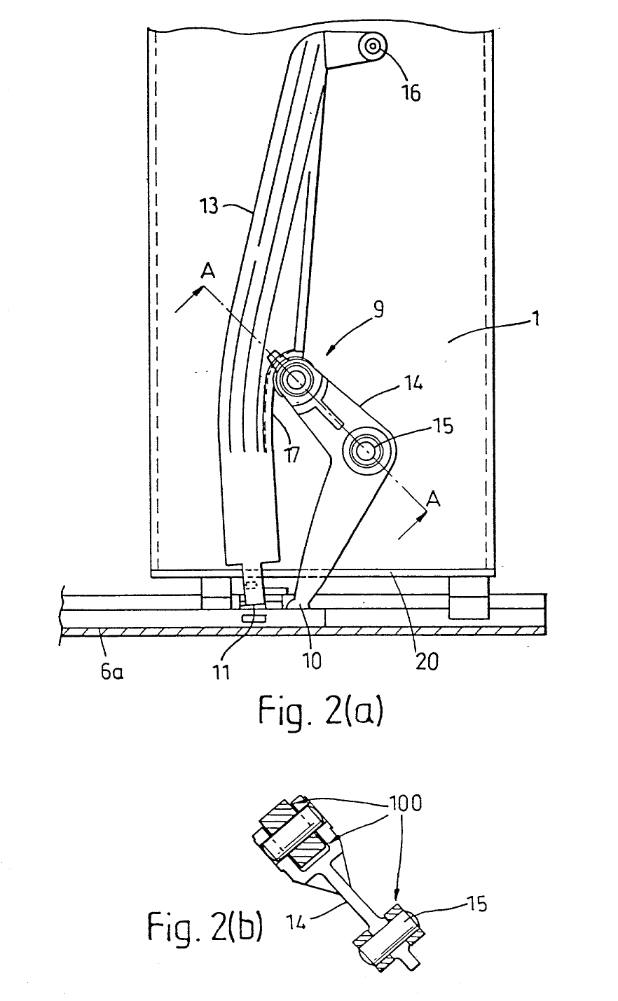

FIG. 2(a) shows the arrangement of the tensioning means which are within the cross member in an open-position and (b) shows the section along the lines A-A in FIG. 2(a).

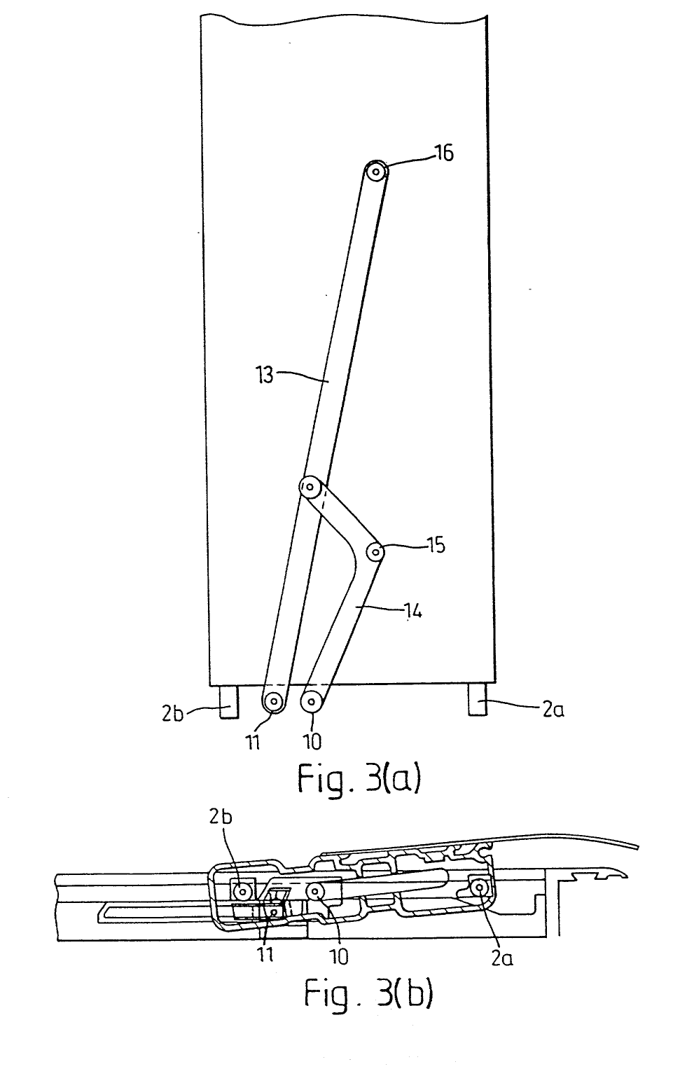

FIGS. 3(a) and (b) shows the position of the locking lever and driving lever relative to the driving member when the roof panel is in an open position;

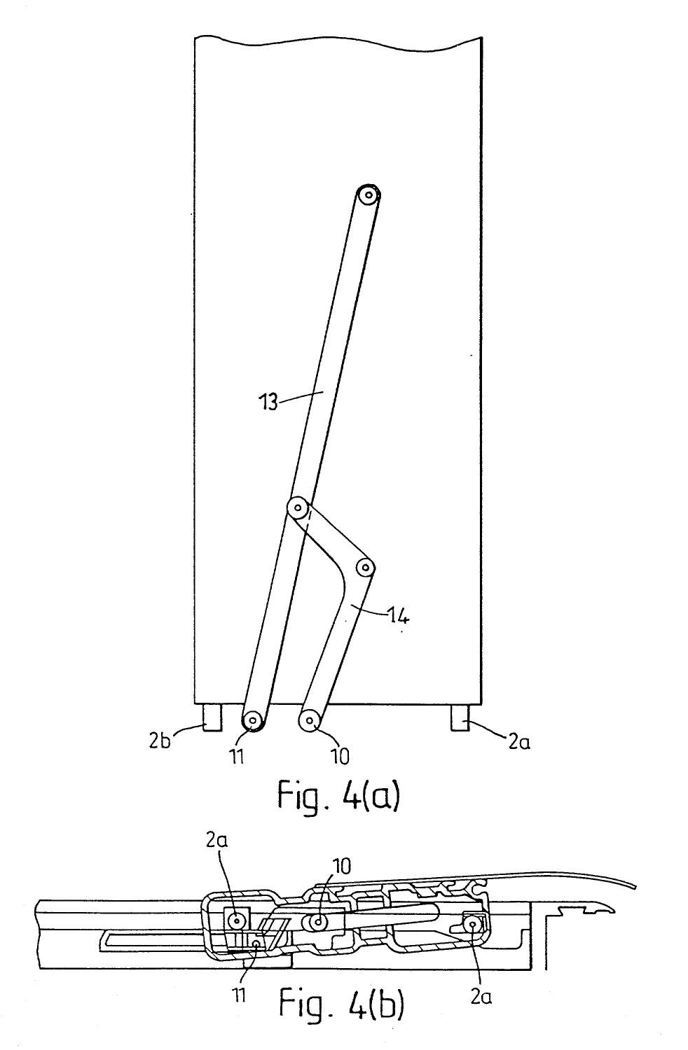

FIGS. 4(a) and (b) shows the position of the locking lever and driving lever as the roof panel reaches an intermediate position defined by the locking opening;

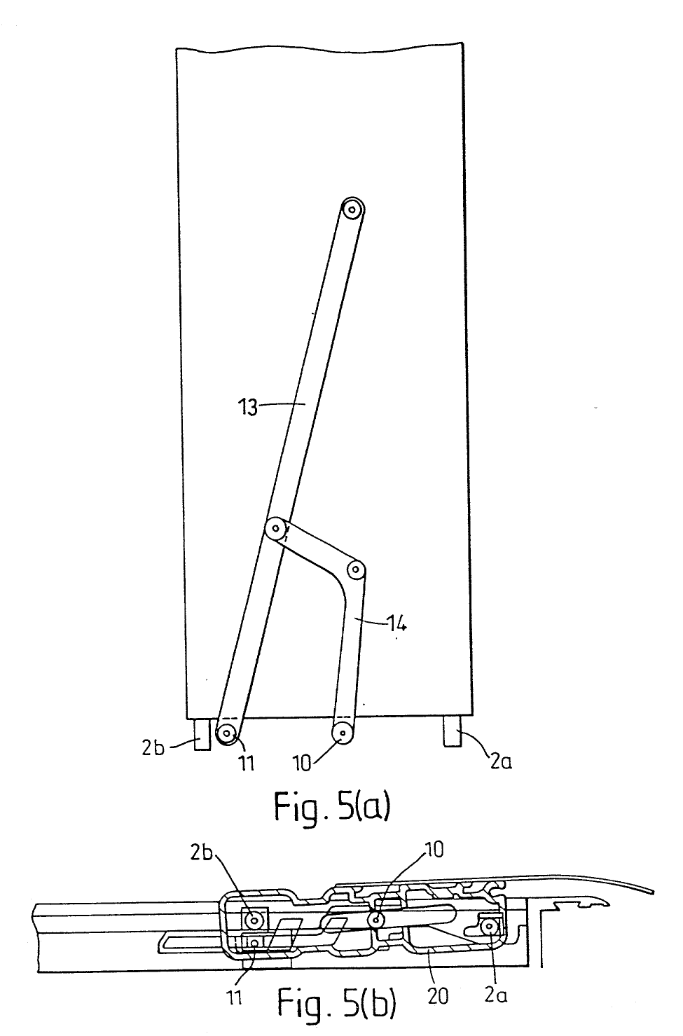

FIGS. 5(a) and (b) shows the effect of continuing to close the roof opening after the locking lever has engaged in the locking opening;

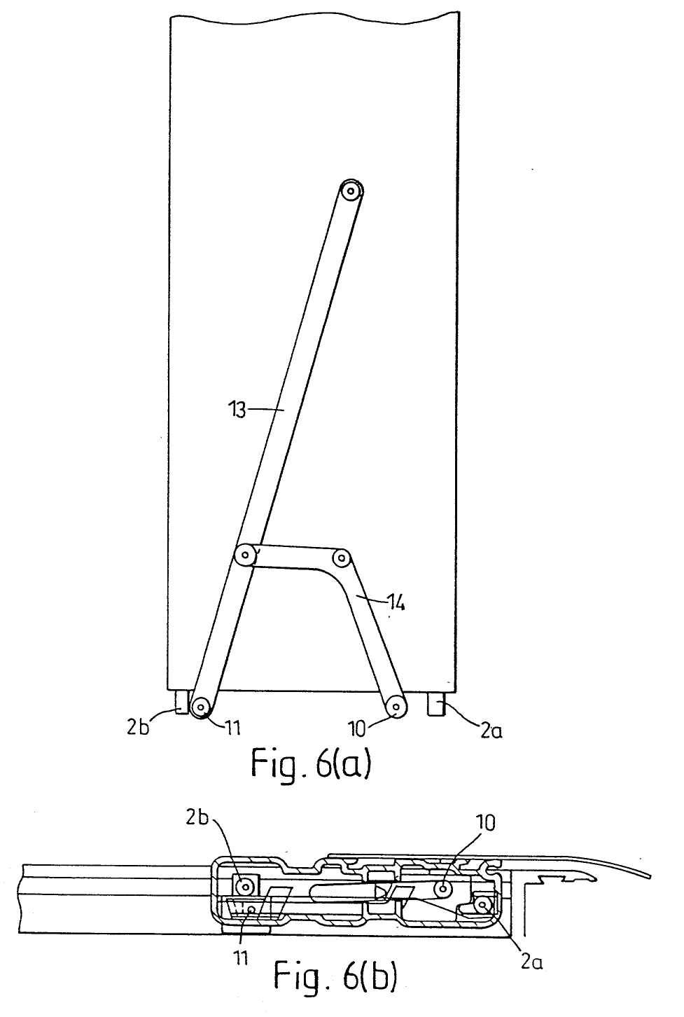

FIGS. 6(a) and (b) shows the final closed position of the roof panel with the roof panel fully tensioned; and

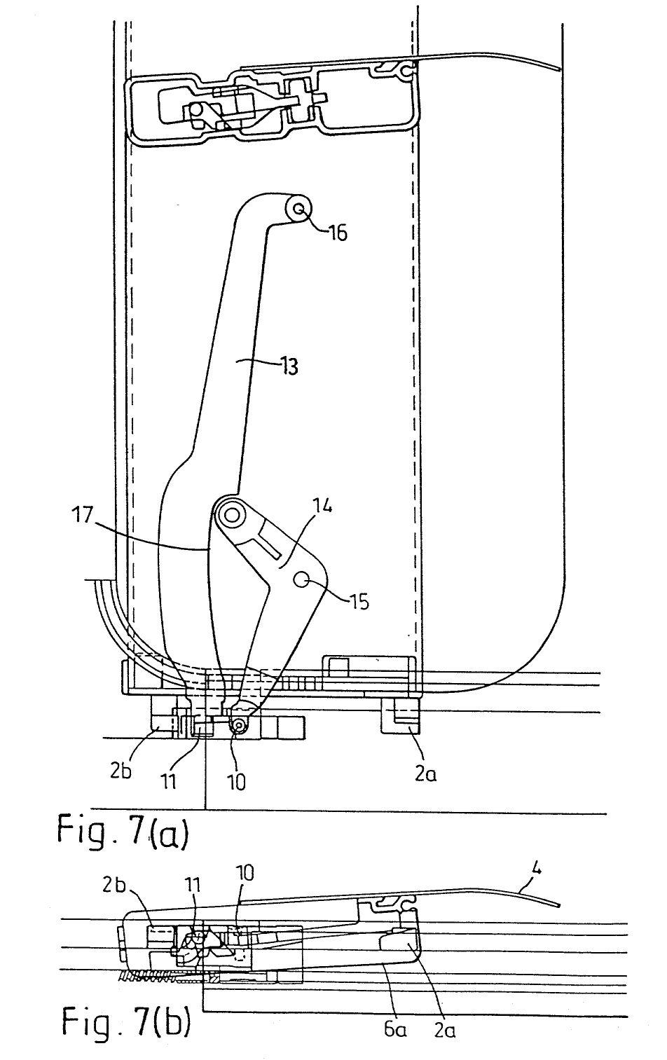

FIGS. 7(a) and (b) and 8(a) and (b) show a practical embodiment of the invention in the fully open and fully closed positions respectively.

FIG. 1 shows an exploded view of the component parts of the closing mechanism in accordance with one embodiment of the present invention.

A cross member 1, of which only the end portion is shown comprises a top panel and a pair of guide blocks 5a, 5b. The cross member is provided with pins 2a, 2b at a respective front and rear portion of the end panel 5a. The pins 2a, 2b are adapted to slide in a guide channel 3a provided in a guide rail 3. A corresponding pair of pins 2c, 2d are provided on the opposite end panel 5b of the cross member and work in a guide channel 3b in a second guide rail 3. In a typical application, the guide rails 3 are provided on opposing sides of a roof opening. A substantially rigid flap 4 of generally rectangular section is secured to the top panel of the cross member. A fabric panel (not shown) is sealingly fixed along an edge to a rear side of the opening and is sealingly fixed along its opposing edge to the top panel of the cross member. The cross member may be slid within the opening to open and close the roof opening, so that in a fully closed position the rigid flap 4 provides a seal with the front side of the opening with the fabric panel tensioned by the cross member.

On the sides of the roof opening, a respective first and second driving slide member 6a, 6b is provided which fits within a guide channel in the guide rails. Each of the driving slides is attached to a motor (not shown) via a cabling 7. Operation of the motor winds the cables around a pulley connected to the motor which in turn causes the driving slides 6a, 6b to slide in the guide channel in the guide rail.

A tensioning mechanism 9 (not shown in FIG. 1 but in FIG. 2) is pivotally attached to the cross member 1 so that a first end portion and a second end portion of the tensioning mechanism protrude through a respective opening channel in the end panel of the cross member.

The driving slide is hingeably attached at a point near to its front end to the first end portion 10 of the tensioning mechanism. The driving slide 6 is also provided with a channel 12 running from a point near to the front of the first end portion 10 of the tensioning mechanism to a point towards the rear. The second end portion 11 of the tensioning mechanism, protrudes through the end guide block away from the cross member, and slidably engages the channel 12 in the driving slide.

Details of the tensioning mechanism are illustrated in FIG. 2, which shows an arrangement of the tensioning mechanism as viewed from above the cross member. The tensioning mechanism is duplicated on each side of the cross member, but only the tensioning mechanism associated with one guide rail is shown.

A locking lever 13 is pivotally and slidably attached to the front member 1 at one end 16, whilst the opposing end of the locking lever protrudes through an opening towards the rear of the end panel. The protruding end portion is slidably engaged with the channel 12 in the driving slide 6, and corresponds to the second end portion 11 of the tensioning mechanism as herein before described.

A driving lever 14 is pivotally and slidably attached to the cross member at a point 15 approximately midway along its length. One end of the driving lever 14 is adapted to move via bearings 100 along a groove 17 provided in the locking lever 13. The opposing end of the driving lever 14 passes through a channel 20 in the end portion of the cross member and is hingeably connected to the front of the driving slide 6. This end portion of the driving lever corresponds to the first end portion 10 of the tensioning mechanism as hereinbefore described.

The arrangement of the driving lever 14 and the locking lever 13 is such that forwards movement of the end portion 10 of the driving lever away from the end portion 11 of the locking lever 13 generates a corresponding, but smaller movement of the cross member 1 in the same direction, i.e. the cross member 1 moves forwardly with respect to the end portion 11.

The operation of the roof assembly will now be explained with reference to FIGS. 3a and 3b to 6a and 6b which show the various steps involved in closing the fabric roof panel.

FIGS. 3(a) and 3(b) show an open position of the roof with the position of the driving lever 14 and locking lever 13 (i.e. the tensioning mechanism) with respect to the position of the cross member 1 and driving slide 6 within the guide rail. In this position, the end portion 11 of the locking lever is held captive in the front part 12a of the channel 12 in the driving slide by the lower surface of the guide channel in the guide rail. Thus, the end portion 11 of the locking lever is fixed relative to the end portion 10 of the driving lever. Accordingly, operation of the electric motor to close the roof moves the driving slide 6 forwardly towards the front of the opening and, simultaneously, moves the cross member 1 forward at the same rate.

The closing action described above and as shown in FIGS. 3a and 3b continues until the cross member 1 reaches an intermediate position within the opening. The intermediate position is defined by a locking opening 18 provided in the lower surface of the guide channel. As the cross member 1 is drawn forward to this position, the end portion 11 of the locking lever is forced down into the locking opening 18 by the downward slope of the front portion 12a of the channel 12 in the driving slide 6 as shown in FIGS. 4a and 4b. The end portion 11 of the locking lever 13 is now free to move away from the end portion of the driving lever 14. Continued movement of the driving slide 6 in the forward direction to close the panel (not shown) results in the end of the locking lever 13 becoming captive in the locking opening 18 due to the profile of the channel 12 in the driving slide.

After the end of the locking lever becomes captive in the locking opening, further movement of the driving slide 6 in the forward direction causes the driving lever end portion 10 to continue to move forward. Because the end portions 10,11 are now moving away from one another, the lever action provided by the driving and locking levers causes the front member 1 to continue moving forward at a slower rate than the driving slide. This is shown in FIGS. 5a and 5b. As can be seen in the figures, the profile of the channel 20 in the end panel 5a causes the front edge of the cross panel 1 to move downwards as the end portion of the driving lever moves along the channel 20. It is the fact that the driving slide now moves forwards at a faster rate than the cross member that allows adequate tensioning of the fabric panel to be achieved.

FIGS. 6a and 6b show the fully closed position of the roof assembly. The end portion 10 of the driving lever 14 has reached the front of the channel in the end portion 5a of the cross member 1, and the front panel 4 has been drawn downwards on to the front edge of the roof opening. The correct tensioning and closing action has been achieved.

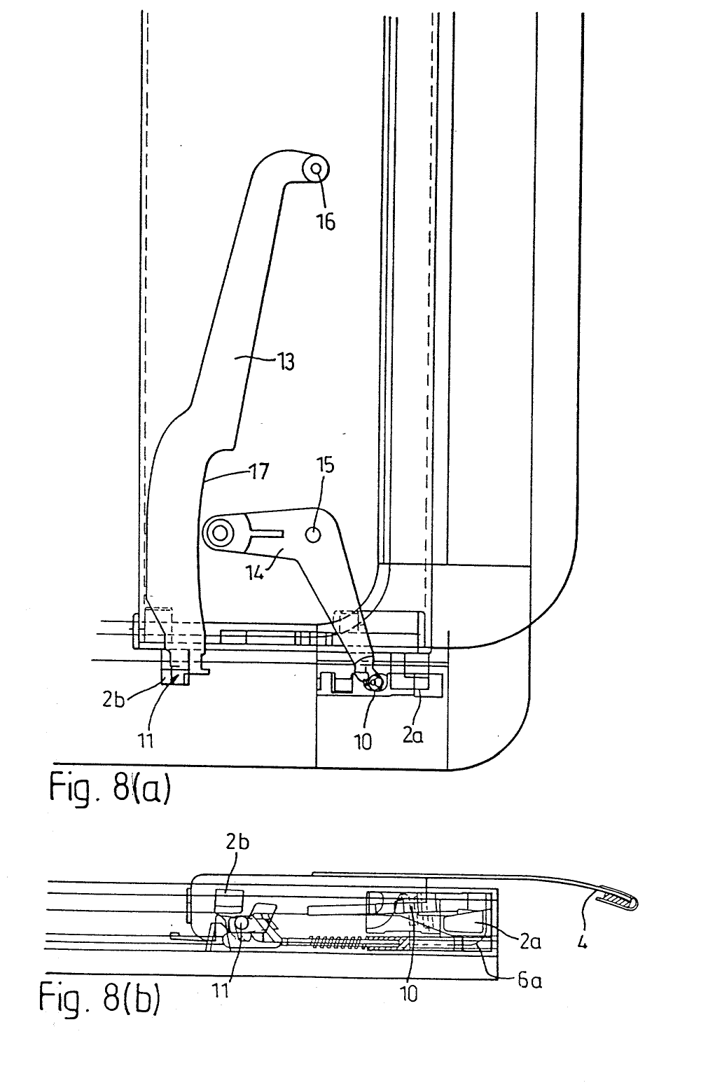

In FIGS. 7(a) and 7(b) and 8(a) and (b), a practical embodiment of the present invention is illustrated. FIGS. 7(a) and 7(b) show the cross member positioned so that the roof is fully opened. FIGS. 8(a) and 8(b) show the roof fully closed.

In an alternative embodiment, the electric motor may be replaced by a manual roof closing mechanism.

It will be understood by the man skilled in the art that the present invention is not limited to the specific arrangement of levers described in the preferred embodiment. The invention lies in the attachment of the tensioning mechanism to the cross member so that only the driving means for guiding the cross member within the opening needs to be accommodated within the guide rails. This allows a slimline elegant design to be achieved whilst enabling the roof to be tensioned using a low power motor. Neither is it to be understood that the invention is limited to the provision of a definite intermediate position at which the end portion of the locking lever is suddenly prevented from any further forward movement. Instead, it should be understood that the invention can be achieved in a manner whereby the transition from a point where the two ends of the tensioning mechanism are fixed relative to one another to a point where they move relative to one another may be quite gradual.

I claim:

1. A fabric roof assembly for a vehicle having a roof panel, said roof panel having an inner periphery defining first and second sides and a front and rear end wall, said sides and walls defining an opening, said fabric roof assembly comprising a series of transverse cross-members, first and second guide rails provided on said first and second side walls respectively, said transverse cross-members being adapted to slide-in said guide rails, a flexible fabric panel supported by said transverse cross-members and having a front end, a front cross-member supporting said front end of said fabric panel, a tensioning mechanism and closing mechanism carried by said front cross-member to tension and close said fabric panel within said opening, and driving members adapted to slide along said guide rails and co-operate with said front cross-member through said tensioning and closing mechanism.

2. A fabric roof assembly according to claim 1 in which a groove is provided in each of said guide rails, wherein said front cross member has a pair of opposing sides and said tensioning mechanism has at least a first end portion and a second end portion associated with each of said sides of said front cross member, each first end portion being fixed to a respective one of said driving members and each of said second end portions being adapted to slide along said groove in a respective one of said guide rails, and wherein said driving members are adapted to move between a first position and an intermediate position and between said intermediate position and a second position, wherein said first and second end portions on each side are fixed relative to one another when said driving members are between said first position and said intermediate position, and said first and second end portions on each side are adapted to move relative to one another upon relative movement of said driving members between said intermediate position and said second position.

3. A fabric roof assembly according to claim 2 wherein a locking opening is provided in each guide rail, and each of said second end portions is adapted to engage a respective one of said locking openings when the driving members fixed to said first end portions are between said intermediate position and said second position.

4. A fabric roof assembly according to claim 3 wherein a groove is provided in each of said driving members supporting said first ends of said tensioning mechanism, each of said a grooves being adapted to locate one of said second end portions of said tensioning mechanism.

5. A fabric roof assembly according to claim 4 wherein said groove in each driving member has a first profile, and a channel is defined in each guide rail having a second profile, said first profile being adapted to co-operate with said second profile to prevent relative movement between said first and second end portions of said tensioning mechanism when said driving member is between said first position and said intermediate position, and said first profile being adapted to co-operate with said second profile to retain said second end portion in said locking opening when said driving member is between said intermediate position and said second position.

6. A fabric roof assembly according to claim 2 wherein each first end portion of the tensioning mechanism defines an end of a locking lever, and each second end portion defines an end of a driving lever, said driving levers and said locking levers being attached pivotally to said cross-member, said levers being so constructed and arranged that a large relative movement of said end portion of each said driving lever away from said end portion of a respective one of said locking levers is adapted to produce a smaller movement of said front cross-member in the direction of movement of the end of the driving lever.

7. A fabric roof assembly according to claim 2 wherein said front cross-member has a front edge and each of said opposing sides of said front cross-member comprises first and second inner wall portions defining the sides of an opening, wherein said first end portions of said tensioning mechanism pass through said openings in said sides of said front cross-member, and wherein each opening is so constructed and arranged that movement of said first end portions away from said second end portions is adapted to cause said first end portions to move along said channels to move said front edge of said front cross-member downwards to effect a seal with said front wall of said opening of said roof panel.

8. A fabric roof according to claim 1 which is electrically operated.

9. A fabric roof assembly according to claim 8 including an electric motor adapted to move said driving members relative to said guide rails.
